(19) United States
(12) Patent Application Publication
(10) Pub. No.: US 2016/0189592 A1
(43) Pub. Date: Jun. 30, 2016

(54) DISPLAY SYSTEM, INFORMATION PROCESSING DEVICE, AND DISPLAY METHOD

(71) Applicant: NEC Display Solutions, Ltd., Tokyo (JP)

(72) Inventor: Hiroshi Kato, Tokyo (JP)

(21) Appl. No.: 14/975,426

(22) Filed: Dec. 18, 2015

(30) Foreign Application Priority Data
Dec. 26, 2014 (JP) 2014-265885

(51) Int. Cl. G09G 3/20; H04N 5/38; H04N 5/44; G06F 3/041; G06F 3/0354

(52) U.S. Cl. CPC G09G 3/2003; G06F 3/0412; G06F 3/03545; H04N 5/44; H04N 5/38; G09G 2320/0666

(57) ABSTRACT

An information processing device includes: an image signal processing unit that processes an image signal representing an image, the image including the region, the image signal processing unit sequentially changing a color to be displayed in the region; an image signal output unit that outputs the image signal to a display device; and a receiver unit that receives, from an input device, a signal that instructs to stop the change of the color. The image signal processing unit stops the change of the color in response to the receiver unit receiving the signal.

This application is based upon and claims the benefit of priority from Japanese patent application No. 2014-265885, filed on Dec. 26, 2014, the disclosure of which is incorporated herein in its entirety by reference.

### BACKGROUND OF THE INVENTION

1. Field of the Invention

The present invention relates to a display system, an information processing device, and a display method.

2. Description of Related Art

In recent years, touch panels that combine a display device and a position detection device are becoming widespread, and are being employed in large devices such as electronic blackboards. For a position detection device such as a touch panel, there have been invented a number of methods for detecting a position input, examples of which include a resistive film method, a surface capacitance method, and a projected capacitance method. Moreover, for example, it has been considered that in an electronic blackboard, a plurality of color image capturing elements are used to thereby detect position input as well as color information, and the image drawn by user gets colors added thereto and is displayed (for example, refer to Japanese Unexamined Patent Application, First Publication No. 2001-67183).

However, in the technique mentioned above, it is sometimes not possible to associate color information with each position input, if position inputs are simultaneously made in several regions. For example, in the case of several people performing drawing simultaneously with different colors on an electronic blackboard, color information input by each person needs to be associated with position information input by each person. However, in the technique mentioned above, this type of situation is not assumed. Therefore it is not possible to associate color information with each position input. Consequently there is a possibility that color input operability may not be improved.

### SUMMARY OF THE INVENTION

The present invention takes into consideration the above points. An exemplary object of the preset invention is to provide a display system, an information processing device, and a display method capable of improving color input operability.

A display system according to a first exemplary aspect of the present invention includes: an information processing device; a display device; and a first input device. The information processing device includes: a receiver unit that receives a first color determination signal from the first input device; an image signal processing unit that processes an image signal representing an image, the image including the first region, the image signal processing unit sequentially changing a first target color that is a color to be displayed in the first region, the image signal processing unit stopping the change of the first target color in response to the receiver unit receiving the first color determination signal; and an image signal output unit that outputs the image signal to the display device. The display device includes: an image signal acceptance unit that accepts the image signal; and a display unit that displays the image represented by the image signal. The first input device includes: a first detection unit that detects the first target color displayed on the display unit, the first detection unit acquiring first target color information that is color information representing the first target color; a first memory unit that stores first registered color information; a first color determination processing unit that determines whether the first target color information is matched with the first registered color information, the first color determination processing unit generating the first color determination signal when the first color determination processing unit has determined that the first target color information is matched with the registered color information; and a first transmission unit that transmits the first color determination signal to the information processing device.

An information processing device according to a second exemplary aspect of the present invention includes: an image signal processing unit that processes an image signal representing an image, the image including the region, the image signal processing unit sequentially changing a color to be displayed in the region; an image signal output unit that outputs the image signal to a display device; and a receiver unit that receives, from an input device, a signal that instructs to stop the change of the color. The image signal processing unit stops the change of the color in response to the receiver unit receiving the signal.

A display method according to a third exemplary aspect of the present invention is for a display system. The display system includes an information processing device, a display device, and a first input device. The first input device stores first registered color information. The display method includes: outputting an image signal to the display device by means of the information processing device, the image signal representing an image including the first region; accepting the image signal by means of the display device; displaying the image represented by the image signal by means of the display device; sequentially changing a first target color that is a color to be displayed in the first region, by means of the information processing device; detecting the first target color by means of the first input device; acquiring first target color information that is color information representing the first target color, by means of the first input device; determining whether the first target color information is matched with the first registered color information, by means of the first input device; generating a first color determination signal by means of the first input device when it has been determined that the first target color information is matched with the first registered color information; transmitting the first color determination signal by means of the first input device; and stopping the change of the first target color by means of the information processing device, in response to the first color determination signal being received.

According to the present invention, color input operability can be improved.

### BRIEF DESCRIPTION OF THE DRAWINGS

FIG. 1 is a schematic diagram showing a schematic configuration of a display system according to a first exemplary embodiment of the present invention.

FIG. 2 is a diagram for describing a brief overview of operations of the display system according to the first exemplary embodiment of the present invention.

FIG. 3 is a diagram for describing a brief overview of a color change process according to the first exemplary embodiment of the present invention.

FIG. 4 is a block diagram showing a schematic function configuration of the display system according to the first exemplary embodiment of the present invention.

FIG. 5A is a diagram showing an example of an image represented by an image signal stored in the information processing device according to the first exemplary embodiment of the present invention.

FIG. 5B is a diagram showing an example of an image represented by an image signal stored in the information processing device according to the first exemplary embodiment of the present invention.

FIG. 5C is a diagram showing an example of an image represented by an image signal stored in the information processing device according to the first exemplary embodiment of the present invention.

FIG. 6 is a sequence diagram showing an example of a flow of a process performed by the display system according to the first exemplary embodiment of the present invention.

FIG. 7 is a flowchart showing an example of a flow of a color registration process performed by an input device according to the first exemplary embodiment of the present invention.

FIG. 8 is a flowchart showing an example of a flow of a color change process performed by the information processing device according to the first exemplary embodiment of the present invention.

FIG. 9 is a flowchart showing an example of a flow of a color determination process performed by the input device according to the first exemplary embodiment of the present invention.

FIG. 10 is a diagram for describing a brief overview of operations of a display system according to a second exemplary embodiment of the present invention.

FIG. 11 is a diagram for describing a brief overview of a color change process according to the second exemplary embodiment of the present invention.

FIG. 12 is a block diagram showing a schematic function configuration of the display system according to the second exemplary embodiment of the present invention.

FIG. 13 is a flowchart showing an example of a flow of a color change process performed by the information processing device according to the second exemplary embodiment of the present invention.

FIG. 14 is a block diagram showing a schematic function configuration of a display system according to a modified example of the present invention.

### EXEMPLARY EMBODIMENT

### First Exemplary Embodiment

### [Brief Overview of Display System]

Hereunder, a first exemplary embodiment of the present invention is described, with reference to the figures.

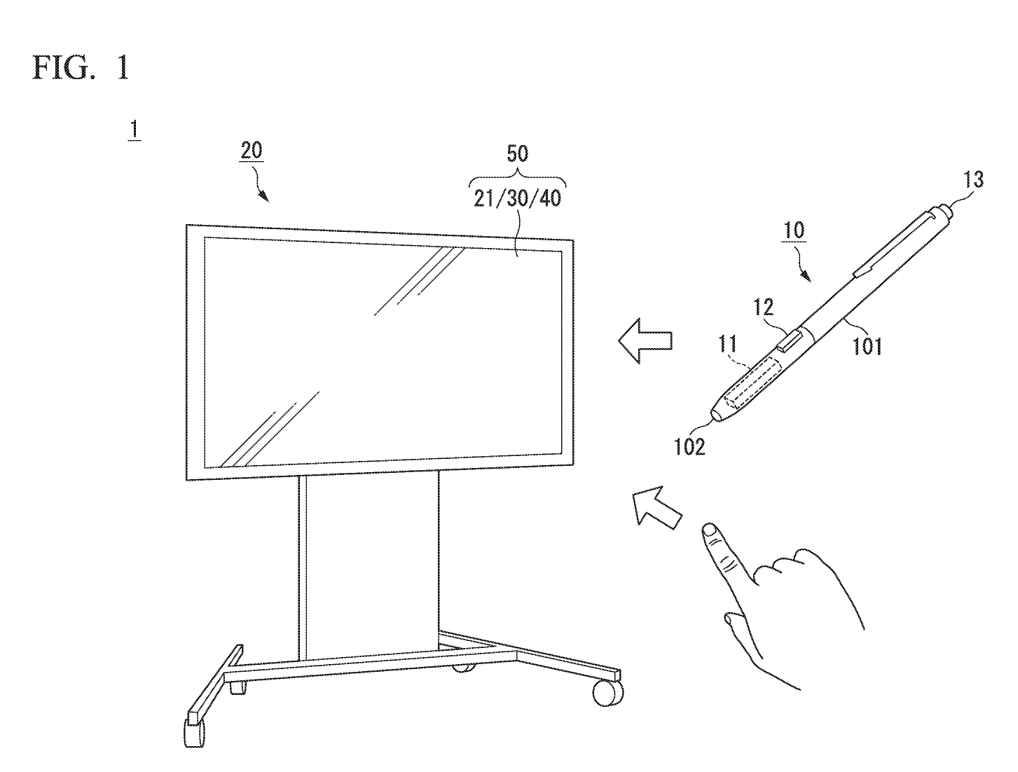

First, a brief overview of a display system 1 according to the first exemplary embodiment is described, with reference to FIG. 1 through FIG. 3.

FIG. 1 is a schematic diagram showing a schematic configuration of the display system 1 according to the first exemplary embodiment.

The display system 1 includes an input device 10, a display device 20, an information processing device 30, and a position detection device 40. The display device 20 includes a display unit 21. The position detection device 40 is laminated and arranged on the display plane of the display unit 21. The display unit 21, the information processing device 30, and the position detection device 40 constitute a so-called touch panel 50. This touch panel 50 changes the output of a display pixel corresponding to a portion that has been touched, according to a touch of a user's finger or the input device 10, and enables handwritten input of the user and display of the input result. Hereunder, display of a handwritten input image performed by the display device 20 is referred to as “drawing”.

A “touch” here refers to a user's finger or the input device 10 being in approximate contact with, in direct contact with, or in the close vicinity of the touch panel 50. That is to say, a “touch” does not have to be a direct contact, and a user's finger or the input device 10 may be distanced from the touch panel 50 by a predetermined distance or less.

The input device 10 includes a casing 101 having a pen shape. A tip end portion of the casing 101 has a hole portion 102. The input device 10 includes, inside the casing 101, a detection unit (color sensor) 11 capable of detecting the color of a target object that comes in contact with the tip end portion of the pen type casing 101. The detection unit 11 detects the target object color by detecting light rays that are emitted from the target object and that enter through the hole portion 102.

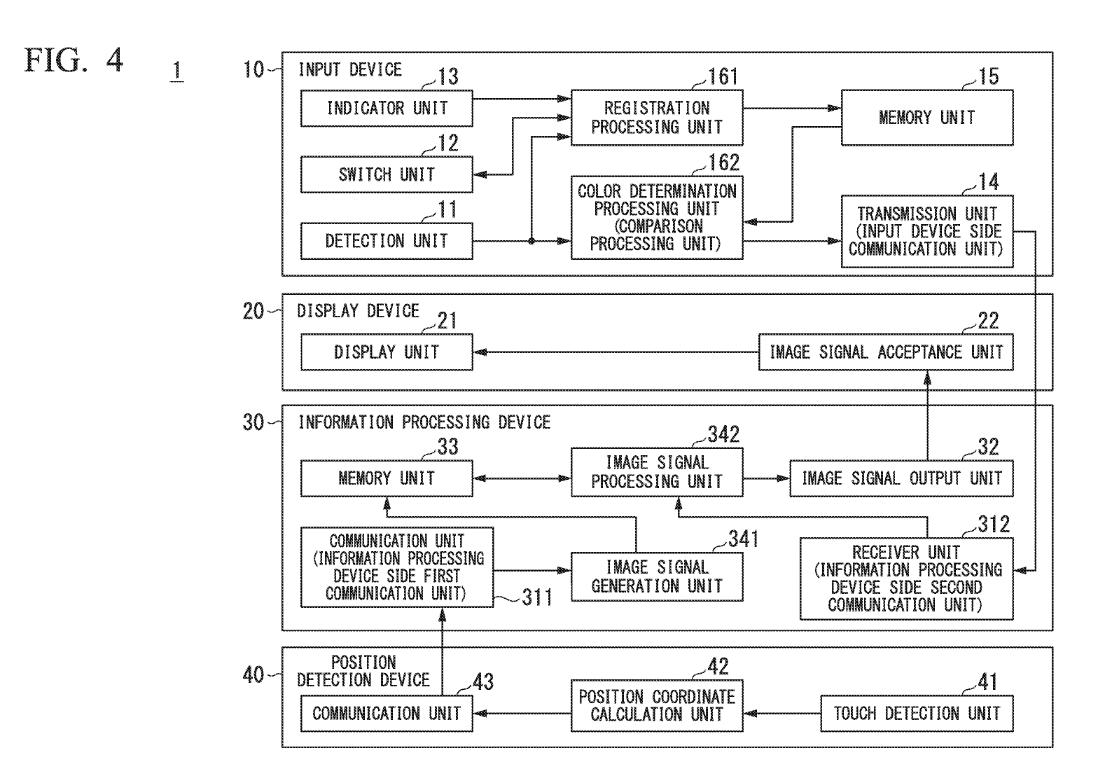

The input device 10 includes a switch unit 12 and an indicator unit 13. For example, the switch unit 12 may be a physical button that protrudes from the casing 101. The input device 10 further includes a memory unit 14 (see FIG. 4). When the switch unit 12 is pressed down, the input device 10 starts a color registration process of storing color information in the memory unit 15. Here, color information refers to information that represents color. The color registration process is described later. The indicator unit 13 may be a light emitting body such as a light emitting diode (LED) for example. The indicator unit 13 notifies the user of the input device 10 of start and/or completion of various types of processes performed by the input device 10 by means of lighting or flashing. Here, the indicator unit 13 is an example of a notification unit that performs information notification to the user of the input device 15 by means of display, sound, and/or vibration. The input device 10 further includes a transmission unit (input device side communication unit) 14 (see FIG. 4), and is capable of communicating with the information processing device 30 in a wireless or wired manner.

The display device 20 is an electronic device that constitutes, for example, an electronic blackboard or interactive whiteboard. The display device 20 performs display based on image signals output from the information processing device 30.

The position detection device 40 detects a user's touch being performed on the display plane of the touch panel 50, and generates position information that represents the coordinates of the touched region. The position detection device 40 outputs the generated position information to the information processing device 30. Here, the area on the touch panel 50 where a touch has been detected, that is, a part region of the display unit 21 that corresponds to the touch, is referred to as a “touch region”.

That is to say, a touch region is a pixel of the display unit 21 corresponding to the position on the touch panel 50 that has been touched. Also, a touch region may be a region that is broadened with respect to the information of the position where the touch is actually detected. Specifically, in the case where the user performs a handwritten input using a thick line, the touch region may include pixels in the close vicinity of the pixel indicated by the position information, according to the thickness of the line. Moreover, the touch region includes the region that has been touched up to each process frame of the information processing device 30.

The information processing device 30 generates an image signal based on the position information generated by the position detection device 40. The information processing device 30 outputs the generated image signal to the display device 20, to thereby display the image on the display unit 21. Here, the information processing device 30 sequentially changes the color of the touch region to generate an image signal. Hereunder, the color of the touch region is referred to as “target color”. Moreover, hereunder, the process of generating an image signal in which the color of a target color is sequentially changed is referred to as a “color change process”.

Here is described a brief overview of operations of the display system 1.

First, in drawing, the user makes the pen tip end of the input device 10 touch the display unit 21 of the display device 20. Next, when the touch panel 50 detects the touch of the input device 10 or the like, the information processing device 30 executes the color change process. On the other hand, the input device 10 executes the color determination process.

Here, the color determination process is described. In the color determination process, the detection unit 11 of the input device 10 sequentially detects the color of the region where the pen tip end is touching, that is, the target color, and acquires target color information, which is color information indicating this target color. For example, target color information is a detection value obtained when the detection unit 11 detects a color. Next, the input device 10 sequentially compares the target color information detected by the detection unit 11 with registered color information stored in the memory unit 15, and determines whether or not the target color information and registered color information match with each other. Here, registered color information is for example color information indicating a color that has been registered in the memory unit 15 by means of a color registration process described later. Next, the input device 10 transmits a color determination signal to the information processing device 30 based on the determination result. More specifically, upon receiving the color determination signal, the information processing device 30 controls the color change process based on this color determination signal, and determines the color of the touched region.

The color determination signal is, for example, a signal for stopping the color change process that is being performed by the information processing device 30. In this case, in the color change process, the information processing device 30 changes the color of the touch region at for example predetermined temporal intervals until this color determination signal has been received. Then when this color determination signal is received, the information processing device 30 determines the color that has been displayed in the touch region, as the color of the touch region.

Alternatively, the color determination signal may be, for example, a signal for making the color change process progress. In this case, in the color change process, the information processing device 30 changes the color of the touch region when this color determination signal is received. On the other hand, when this color determination signal cannot be received for a predetermined period of time or longer, the information processing device 30 determines the color that has been displayed in the touch region at the time, as the color of the touch region.

Hereunder, as an example, the color determination signal is described as a signal for stopping the color change process (hereunder, referred to as “color change stop command”).

### [Brief Overview of Color Registration Process]

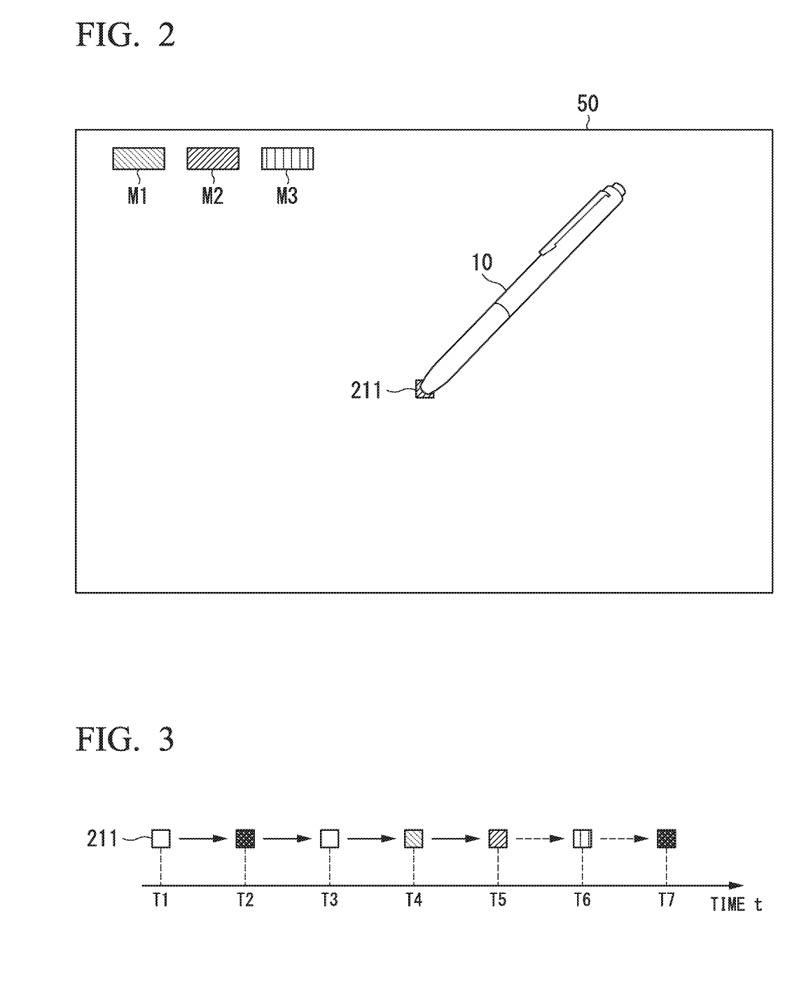

Next, the color registration process performed by the input device 10 is described, with reference to FIG. 2.

FIG. 2 is a diagram for describing a brief overview of operations of the display system 1 according to the first exemplary embodiment.

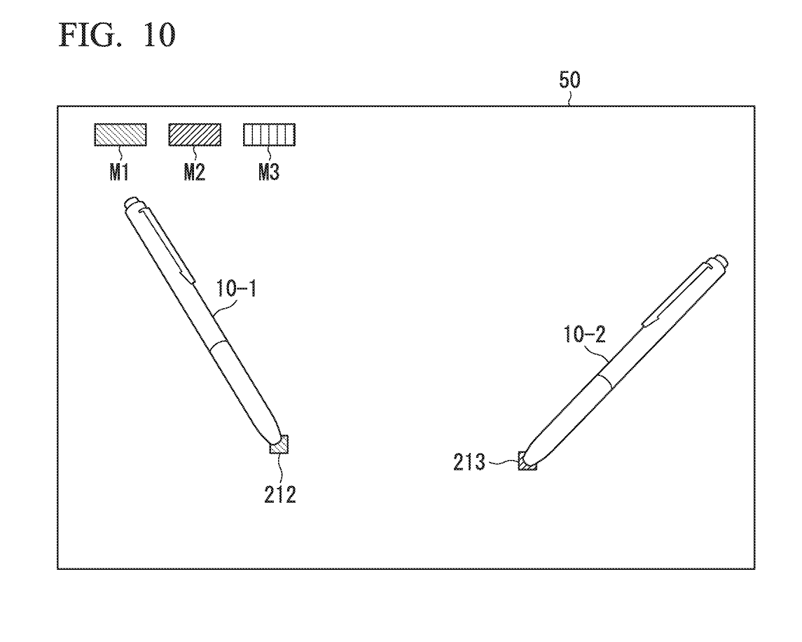

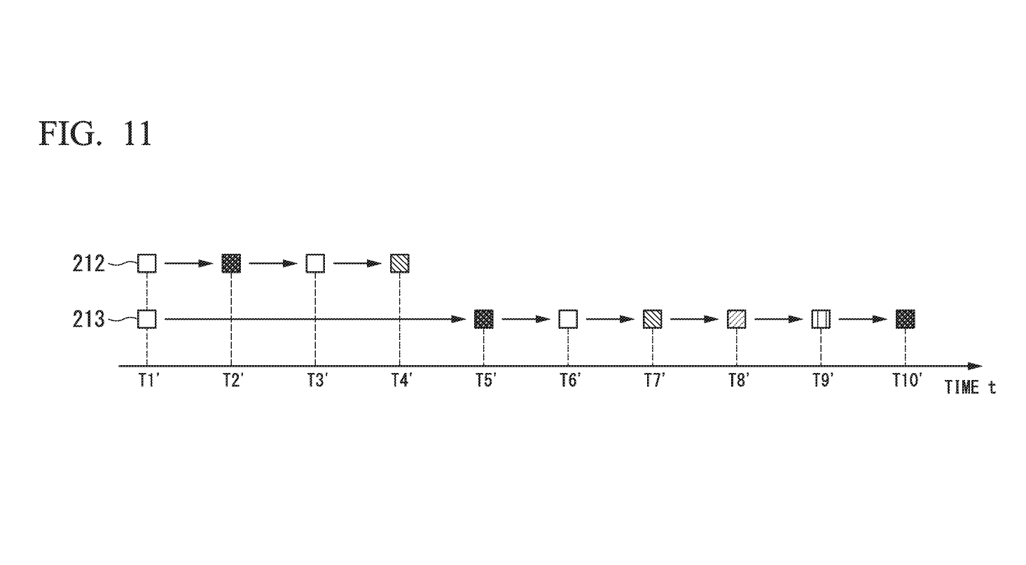

In the example shown in FIG. 2, the touch panel 50 is displaying color markers M1 through M3. The color markers M1 through M3 are markers that respectively represent different colors, and represent colors that can be input by the input device 10. The color represented by the color marker may be arbitrarily selected by the user. In FIG. 2, FIG. 3, FIG. 10, and FIG. 11, the hatching of each region represents a color. Hereunder is a description as an example in which the color markers M1 through M3 are respectively displaying red color, blue color, and green color. Drawing by means of the colors represented by the color markers M1 through M3 is made possible by the input device 10 registering the colors represented by the color markers M1 through M3 thereinto. Hereunder, the process in which the input device 10 registers a color for specifying a drawing color is referred to as “color registration process”.

Here is described an example of the color registration process. The user causes the pen tip end of the input device 10 to touch any one of the color markers M1 through M3, and presses the switch unit 12 down. When the switch unit 12 is pressed down, the input device 10 stores in the memory unit 15, color information related to the color detected by the detection unit 11, to thereby register the color represented by the color marker that is being touched. When the registration is completed, the input device 10 lights the indicator unit 13, and notifies the user of the completion of the color registration process.

### [Brief Overview of Color Change Process]

Next, the color change process performed by the information processing device 30 is described, with reference to FIG. 2 and FIG. 3.

In the example shown in FIG. 2, the input device 10 is touching a region 211 of the touch panel 50, using the pen tip end. When the touch on the touch panel 50 is detected, the information processing device 30 performs the color change process that sequentially changes the color of this touch region 211.

Here, the color change process is described. First, when the touch on the touch panel 50 is detected, the information processing device 30 starts the color change process. Next, the information processing device 30 displays a trigger in the touch region. Then the display device 20 sequentially changes the color of the touch region to colors that the input device 10 can register. The order of color change is preliminarily determined.

The trigger is a trigger for causing the input device 10 to start the color determination process. For example, trigger means displaying a predetermined color. Moreover, trigger means, for example, displaying several colors in a predetermined order. Hereunder, as an example, the trigger is described as displaying white color after black color.

FIG. 3 is a diagram for describing a brief overview of the color change process according to the first exemplary embodiment.

FIG. 3 shows temporal changes in the color of the region 211 shown in FIG. 2. In the example shown in FIG. 3, the horizontal axis represents time t, showing the time shifting from the point in time T1 through to the point in time T7. That is to say, the information processing device 30 sequentially changes the color of the touch region 211 to the colors associated respectively with the point in time T1 through to the point in time T7 in FIG. 3. Specifically, unless a color change stop command is received from the input device 10, the information processing device 30 changes the color of the touch region 211, for example, in the order of white color, black color, white color, red color, blue color, green color, and black color at the point in time T1 through to the point in time T7. The order of the colors displayed in the color change process may be arbitrarily defined by the user or the manufacturer of the information processing device 30. In the color change process, the length of time during which each color is displayed need not be constant. For example, the information processing device 30 may display the color of the trigger for longer than other colors.

As an example, here is described a case where the length of time during which each color is display is constant.

In FIG. 3, the point in time T1 is a point in time before the touch made on the touch panel 50 is detected. The point in time T2 is a point in time immediately after the touch made on the touch panel 50 is detected. That is to say, the touch on the touch panel 50 is detected between the point in time T1 and the point in time T2, and the information processing device 30 starts the color change process. Once the color change process starts, the information processing device 30 first displays the trigger of a black color and a white color trigger at the point in time T2 and point in time T3 to thereby cause the input device 10 to start the color determination process. Then, the information processing device 30 sequentially changes the target color until a color change stop command has been received. For example, if a color change stop command is received between the point in time T5 and the point in time T6, the information processing device 30 stops changing color of the touch region 211, and determines the color of the touch region as blue color, which is displayed on the display unit 21 at the time. If the color change stop command is not received, the information processing device 30 determines a predetermined color such as black color as the color of the touch region 211 at the point in time when color change has completed a cycle. Accordingly, for example, in the case where the user performed touch using their finger without using the input device 10, the information processing device 30 may perform drawing using a predetermined color.

### [Configuration of Input Device]

Next, the configurations of various devices included in the display system 1 are described, with reference to FIG. 4.

FIG. 4 is a block diagram showing a schematic function configuration of the input device 10, the information processing device 30, and peripheral devices according to the first exemplary embodiment.

First, the configuration of the input device 10 is described.

The input device 10 includes a detection unit 11, a switch unit 12, an indicator unit 13, a transmission unit (input device side communication unit) 14, a memory unit 15, a registration processing unit 161, and a color determination processing unit (comparison processing unit) 162. The registration processing unit 161 and the color determination processing unit 162 are realized by means of a micro controller (not shown in the figure) provided in the input device 10 for example.

The detection unit 11 includes a color sensor, and detects color information. The detection unit 11 outputs the detected color information to the registration processing unit 161 and the color determination processing unit 162.

The switch unit 12 outputs a signal according to a press down operation made thereon, to the registration processing unit 161.

The indicator unit 13 performs lighting, flashing, and/or extinction, according to a request from the registration processing unit 161. In the first exemplary embodiment, as an example, the indicator unit 13 indicates start of the color registration process by means of lighting, and indicates failure of the color registration process by means of flashing.

The transmission unit 14 includes a communication interface, and transmits a signal to the information processing device 30.

The memory unit 15 includes such as a ROM (read only memory) or a RAM (random access memory). Moreover, the memory unit 15 may include such as an EEPROM (electrically erasable programmable read only memory), or a flash memory. The memory unit 15 stores, for example, information used by the micro controller (microcomputer) provided in the input device 10 for performing a process, as well as process results.

The memory unit 15 stores color information. The color information is information that represents a color, and for example, it is a color number that represents a color using a hexadecimal number of six digits. The color number may be, for example, a number that represent a color tone of a maximum number of colors such as 256 colors, 8 colors, and less. Hereunder, the color information is assumed as a color number. Moreover, the memory unit 15 stores the color number of a trigger. In other words, the memory unit 15 stores trigger information that represents a trigger.

The registration processing unit 161 executes the color registration process. In the color registration process, first, upon receiving a signal from the switch unit 12 according to a press down operation performed thereon, the registration processing unit 161 outputs a lighting command to the indicator unit 13. Next, the registration processing unit 161 receives a color number output from the detection unit 11 for a predetermined period of time for example, and decides the color number to be registered. At this time, the registration processing unit 161 may perform an arbitrary process for increasing the precision of the color number to be registered, based on the output value from the detection unit 11. The registration processing unit 161 stores the decided color number into the memory unit 15, and registers the color. Upon storing the color number in the memory unit 15, the registration processing unit 161 outputs an extinction command to the indicator unit 13. In the case where a color number to be registered cannot be decided within the predetermined period of time, or in the case where color number registration to the memory unit 15 failed, the registration processing unit 161 outputs a flashing command to the indicator unit 13. Hereunder, the color registered by means of the color registration process is referred to as “registered color”. Furthermore, hereunder, the color that can be registered by means of the color registration process is referred to as “candidate color”.

The color determination processing unit 162 compares the color number output from the detection unit 11 with the color number of the trigger stored in the memory unit 15. If as a result of the comparison, the color represented by the color number output from the detection unit 11 is determined as matching with the color of the trigger, the color determination process starts. In the color determination process, the color determination processing unit 162 receives the color number from the detection unit 11, and compares the received color number with the color number of the registered color stored in the memory unit 15. If as a result of the comparison, the color represented by the color number received from the detection unit 11 is determined as matching with the registered color, the color determination processing unit 162 transmits, via the transmission unit 14, a color change stop command to the information processing device 30.

In the comparison made by the color determination processing unit 162, color matching does not always mean matching of color numbers. For example, in the case where between the colors represented by the compared color numbers, hue, brightness, and saturation converge within a predetermined range, the color determination processing unit 162 may determine the colors as matching.

### [Configuration of Position Detection Device]

Next, the configuration of the position detection device 40 is described.

The position detection device 40 includes a touch detection unit 41, a position coordinate calculation unit 42, and a communication unit 43 that communicates with the information processing device 30.

The touch detection unit 41 detects a touch on the touch panel 50. Examples of the touch detection method of the touch detection unit 41 include a resistive film method, a surface capacitance method, a projected capacitance method, an ultrasonic surface acoustic wave method, an infrared optical imaging method, and an infrared ray cutting-off method.

The position coordinate calculation unit 42 calculates the coordinate of a touch position detected by the touch detection unit 41. The position coordinate calculation unit 42 transmits, to the information processing device 30 via the communication unit 43, position information that represents the coordinate of the calculated touch position. That is to say, the touch detection unit 41 and the position coordinate calculation unit 42 constitute a position detection unit that detects position information representing the input position on the display unit 21.

### [Configuration of Information Processing Device]

Next, the configuration of the information processing device 30 is described.

The information processing device 30 includes a communication unit (information processing device side first communication unit) 311, a receiver unit (information processing device side second communication unit) 312, an image signal output unit 32, a memory unit 33, an image signal generation unit 341, and an image signal processing unit 342.

The transmission unit 311 includes a communication interface, and communicates with the information processing device 40. The communication unit 311 receives position information from the position detection device 40, and outputs the received position information to the image signal generation unit 341.

The receiver unit 312 includes a communication interface, and communicates with the input device 10. Upon receiving a color change stop command from the input device 10, the receiver unit 312 outputs the received color change stop command to the image signal processing unit 342. In this manner, the receiver unit 312 functions as a receiver unit that receives a color determination signal from the input device 10.

The image signal output unit 33 includes a communication interface, and communicates with the display device 20. The image signal output unit 33 outputs an image signal to the display device 20.

The memory unit 33 includes such as a ROM or a RAM. Moreover, the memory unit 33 may include such as a HDD (hard disc drive), an EEPROM, or a flash memory. The memory unit 33 stores, for example, information used by a CPU (central processing unit, not shown in the figure) provided in the information processing device 30 for performing a process, as well as process results. The image signal generation unit 341 and the image signal processing unit 342 are realized, for example, by the CPU executing a program stored in the memory unit 33.

Moreover, the memory unit 33 stores image signals that represent images per frame (hereunder, referred to as “frame image”), and image signals that represent images that have been accumulated in the previous process (hereunder, referred to as “accumulated image). A frame image represents an image input to the frame, and it is an image representing a difference from the image that has been input until the previous frame. In other words, among the pixels in images of a temporal sequence of each frame, a frame image is an image representing a region that is formed with pixels of a different display, between two temporally consecutive frame images. Furthermore, in other words, a frame image is an image that represents a touch region.

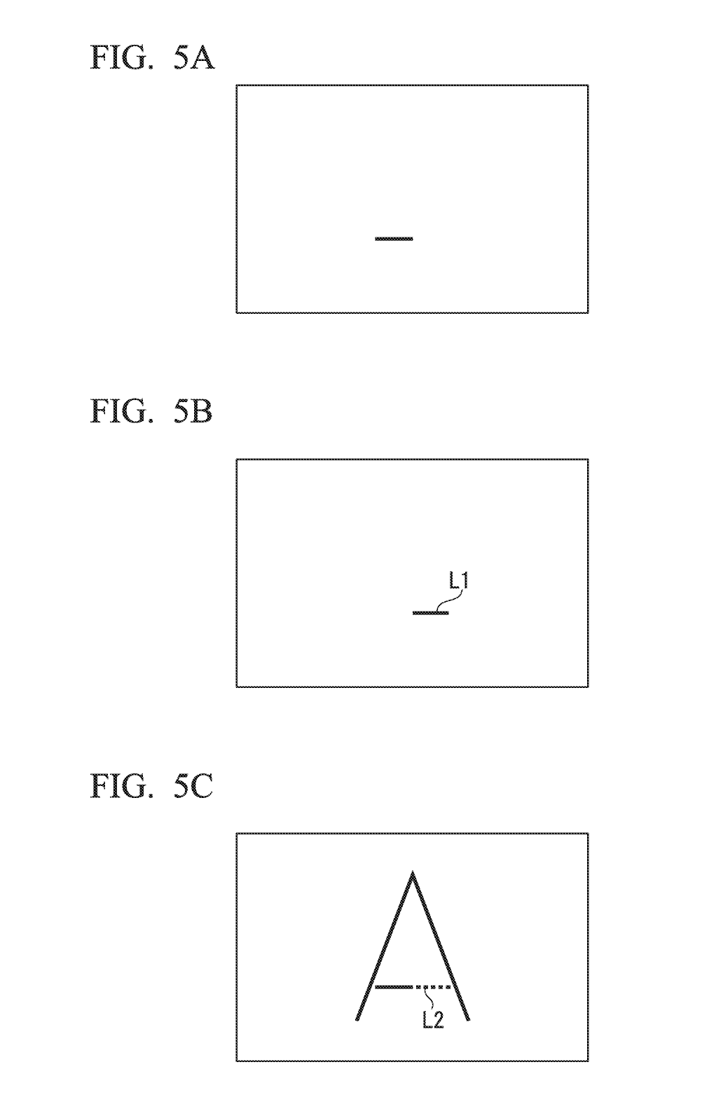

Here, an image stored in the memory unit 24 is described, with reference to FIG. 5A through 5C.

FIG. 5A through 5C are diagrams showing an example of an image represented by an image signal stored in the memory unit 24 of the display device 20 according to the first exemplary embodiment.

FIG. 5A through 5C show various images in a process of a character “A” being input on the touch panel 50.

FIG. 5A shows an example of a frame image at a given frame F1.

FIG. 5B shows an example of a frame image at a frame F2 following the frame F1.

FIG. 5C shows an example of an accumulated image at a frame F2.

In the first exemplary embodiment, color change in the color change process is performed on a per frame image basis.

The frame image, the color of which has been determined in the color change process, is integrated into the accumulated image.

Specifically, for example, at the frame F2, the color change process is executed with respect to the line segment L1 shown in FIG. 5B. Moreover, at the frame that follows the frame F2, the broken line segment L2 shown in FIG. 5C is integrated with the accumulated image (solid line portion in FIG. 5C) up to the frame F2, using the color that has been determined by the color change process with respect to the line segment L1 at the frame F2.

The image signal generation unit 341 acquires position information from the position detection device 40 via the communication unit 311 at each frame. Based on the acquired position information, the image signal generation unit 32 generates an image signal that represents the image corresponding to the handwritten input performed on the touch panel 50. That is to say, the image signal generation unit 341 generates an image signal that represents a frame image. The image signal generation unit 341 stores the generated image signal in the memory unit 33.

The image signal processing unit 342 processes (integrates) the image signal of the accumulated image stored in the memory unit 33, and the image signal of the frame image, and outputs the processed image signal to the display device 20 via the image signal output unit 32.

Here, the color change process performed by the image signal processing unit 342 is described.

First, the image signal processing unit 342 acquires from the memory unit 33, the image signal of the accumulated image and the image signal of the frame image, at predetermined temporal intervals. Next, the image signal processing unit 342 selects the color of the touch region represented by the image signal of the frame image. Here, the color of the touch region is selected in the predetermined order as described above. Next, the image signal processing unit 342 integrates the image signal of the accumulated image and the image signal of the frame image, and generates an image signal that represents an image in which the pixel color of the touch region among the colors of the respective pixels of the accumulated image is treated as a selected color. Then, the image signal processing unit 342 outputs the generated image signal to the display device 20.

Moreover, upon receiving a color change stop command from the input device 10 via the receiver unit 312, the image signal processing unit 342 stores the image signal being output at the time, into the memory unit 33 as the image signal of the accumulated image. Furthermore, at this time, the image signal processing unit 342 deletes from the memory unit 33 the frame image that represents the touch region where the color has been determined in the color change process.

### [Configuration of Display Device]

Next, the configuration of the display device 20 is described.

The display device 20 includes a display unit 21 and an image signal acceptance unit 22.

The display unit 21 includes a display device such as a liquid crystal display (LCD) or an organic EL (electro-luminescence) display. The display unit 21 displays an image based on an image signal accepted from the image signal acceptance unit 22.

The image signal acceptance unit 22 accepts an image signal output from the information processing device 30, and outputs it to the display unit 21.

### [Example of Color Change Process]

Here, a specific example of the color change process performed by the image signal processing unit 342 is described, with reference to FIG. 3 and FIG. 5A through FIG. 5C. As an example, it is assumed that the frame image shown in FIG. 5B and the accumulated image shown in FIG. 5C are stored in the memory unit 33, and the color of the touch region is changed in the order shown in FIG. 3. In the color change process, the image signal processing unit 342 generates an image signal of an image in which the accumulated image shown with the solid line in FIG. 5C and the frame image shown with the broken line L2 are integrated. At this time, the image signal processing unit 342 sequentially generates an image signal in which the color of only the pixels corresponding to the broken line L2, which is the touch region, is changed.

Specifically, first, the image signal processing unit 342 generates an image signal in which the pixels corresponding to the broken line L2 are of black color, which is the color of the trigger, and displays this image on the display unit 21 for a predetermined period of time. Next, the image signal processing unit 342 generates an image signal in which the pixels corresponding to the broken line L2 are of white color, which is the color of the trigger, and displays this image on the display unit 21 for a predetermined period of time. Next, the image signal processing unit 342 generates an image signal in which the pixels corresponding to the broken line L2 are of red color, which is the color of the color marker M1, and displays this image on the display unit 21 for a predetermined period of time. Subsequently, in a similar manner, the image signal processing unit 342 sequentially generates image signals of an image in which the color of the pixels corresponding to the broken line L2 are changed, and displays this image on the display unit 21 for a predetermined period of time. Here, the predetermined period of time is a length of time sufficient, for example, for the input device 10 to detect the color displayed on the display unit 21, to transmit a color determination signal based on the detected color to the information processing device 30, and for the information processing device 30 to recognize this color determination signal. Moreover, the length of time of each frame is sufficient to complete the cycle of color change in the color change process.

In the case where the color change stop command is accepted from the input device 10 via the receiver unit 312 in the middle of the color change process, or where color change in the color change process has completed its cycle, the image signal processing unit 342 stores the image signal being output at the time into the memory unit 33 as an image signal of the accumulated image. In this manner, the image signal processing unit 342 determines the color of the touch region by means of the color change process.

### [Operation of Display System: Basic Operation]

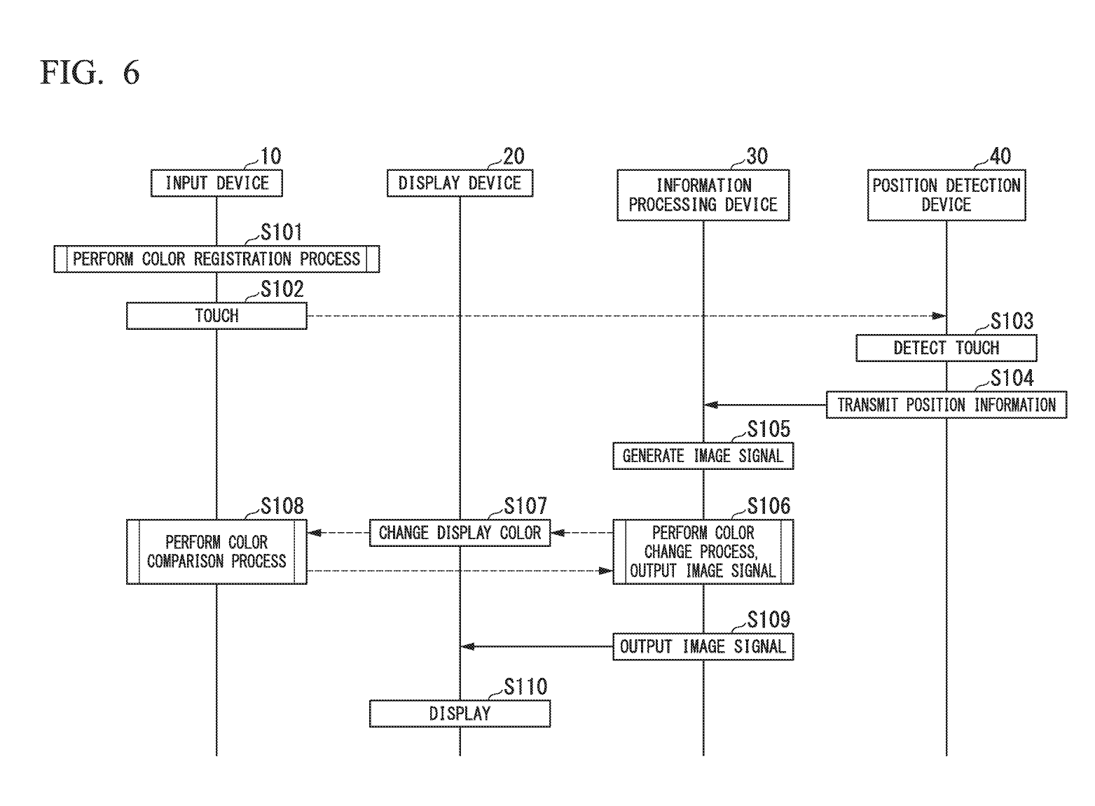

Next, operations of the display system 1 are described, with reference to FIG. 6 through FIG. 9.

FIG. 6 is a sequence diagram showing an example of a process flow of the display system 1 according to the first exemplary embodiment.

(Step S101) First, the input device 10 executes the color registration process according to the operation of the user. Then, the display system 1 causes the process to proceed to step S102.

(Step S102) Next, the input device 10 is operated by the user, and the pen tip end is touched on the touch panel 50. Then, the display system 1 causes the process to proceed to step S103.

(Step S103) Next, the position detection device 40 detects the touch on the touch panel 50, and generates position information that represents the touch region. Then, the display system 1 causes the process to proceed to step S104.

(Step S104) Next, the position detection device 40 transmits the generated position information to the information processing device 30. Then, the display system 1 causes the process to proceed to step S105.

(Step S105) Next, the information processing device 30 generates an image signal of a frame image, based on the position information transmitted from the position detection device 40. The information processing device 30 stores into the memory unit 33 the image signal of the generated frame image. Then the display system 1 causes the process to proceed to step S106.

(Step S106) Next, the information processing device 30 executes the color change process. In the color change process, the information processing device 30 outputs to the display device 20 the image signal in which the color of the touch region is sequentially changed. Then, the display system 1 causes the process to proceed to step S107.

(Step S107) Next, the display device 20 displays the image signal acquired from the information processing device 30. In the image represented by this image signal, the color of the touch region is sequentially changed. Then, the display system 1 causes the process to proceed to step S108.

(Step S108) Next, the input device 10 detects a trigger displayed on the display device 20, and starts the color determination process. The input device 10, in the color determination process, transmits a color change stop command to the display device 20.

(Step S109) In the color change process, upon receiving the color change stop command from the input device 10, the information processing device 30 determines the color of the touch region. Specifically, the information processing device 30 stores the image signal that was being output at the time of receiving the color change stop command into the memory unit 33 as an image signal of the accumulated image. Then the information processing device 30 outputs the image signal of the accumulated image to the display device 20. Subsequently, the display system 1 causes the process to proceed to step S110.

(Step S110) Next, the display device 20 displays the accumulated image based on the image signal acquired from the information processing device 30. Then, the display system 1 ends the process shown in FIG. 6.

### [First Operation of Input Device: Color Registration Process]

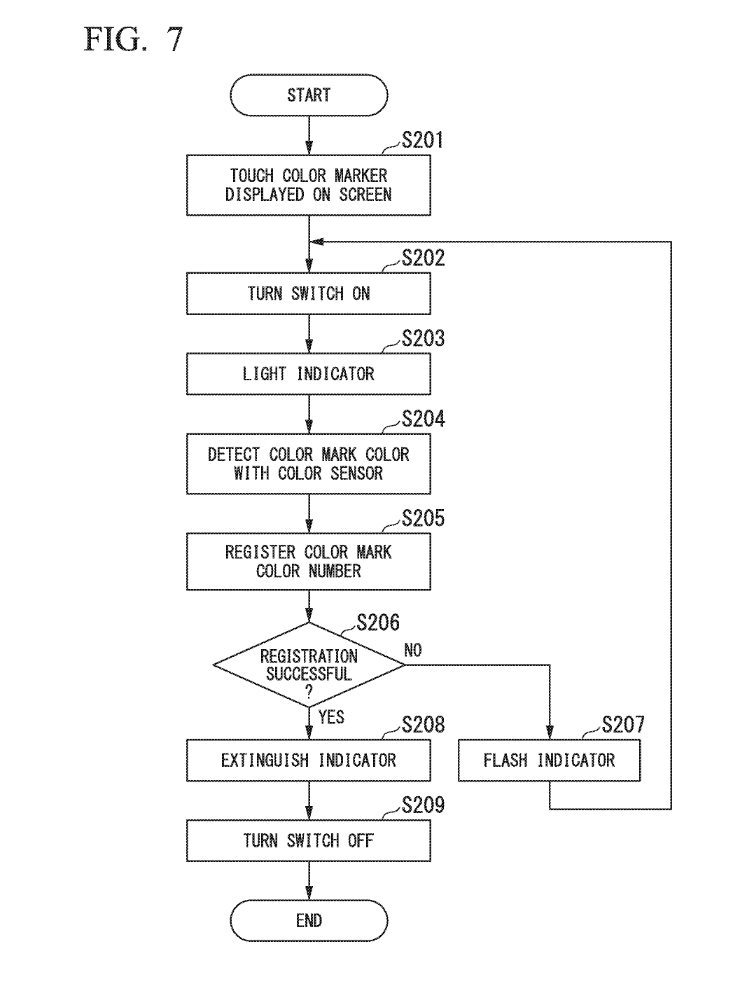

FIG. 7 is a flowchart showing an example of a flow of the color registration process performed in the input device 10 according to the first exemplary embodiment.

(Step S201) First, the input device 10 is operated by the user, and the pen tip end portion of the casing 101 is touched on a color marker displayed on the screen of the touch panel 50. Then, the process of step S202 is performed.

(Step S202) Next, the registration processing unit 161 of the input device 10 accepts a press down operation of the switch unit 12 performed by the user. Then, the registration processing unit 161 causes the process to proceed to step S203.

(Step S203) Next, the registration processing unit 161 outputs a lighting command to the indicator unit 13, and causes the indicator unit 13 to light. Then, the registration processing unit 161 causes the process to proceed to step S204.

(Step S204) Next, the registration processing unit 161 acquires the color number of the color marker detected by the detection unit 11. Then, the registration processing unit 161 causes the process to proceed to step S205.

(Step S205) Next, the registration processing unit 161 stores the acquired color number into the memory unit 24, and registers the color. Then, the registration processing unit 161 causes the process to proceed to step S206.

(Step S206) Next, the registration processing unit 161 determines whether or not the color registration has succeeded. If the color registration has not been successful, that is, if the color registration has failed (NO in step S206), the registration processing unit 161 causes the process to proceed to step S207. On the other hand, if the color registration has been successful (YES in step S206), the registration processing unit 161 causes the process to proceed to step S208.

(Step S207) In the case of “NO” in step S206, the registration processing unit 161 outputs a flashing command to the indicator unit 13, and causes the indicator unit 13 to flash. Then, the registration processing unit 161 causes the process to return to step S202.

(Step S208) In the case of “YES” in step S206, the registration processing unit 161 outputs an extinction command to the indicator unit 13. Then, the registration processing unit 161 causes the process to proceed to step S209.

(Step S209) Next, the registration processing unit 161 turns the switch unit 12 OFF. Then, the input device 10 ends the process shown in FIG. 7.

### [Operation of Display Device: Color Change Process]

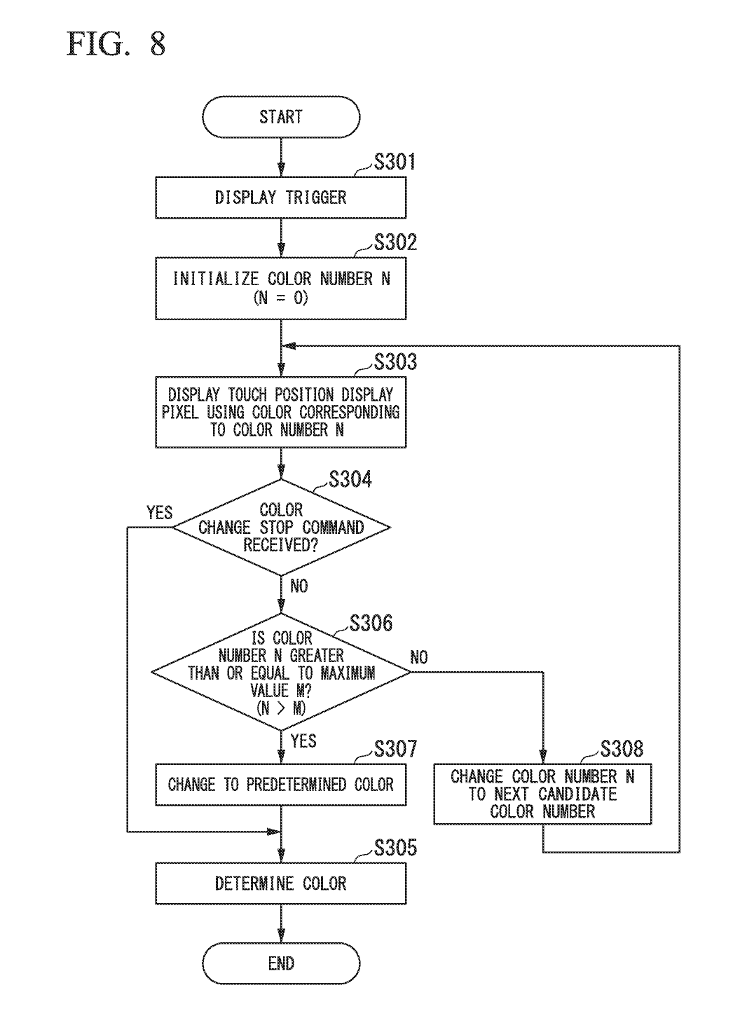

FIG. 8 is a flowchart showing an example of a flow of a color change process performed by the information processing device 30 according to the first exemplary embodiment.

(Step S301) First, the image signal processing unit 342 displays, on the display unit 21, the touch region shown by the frame image in the color of the trigger. Then, the image signal processing unit 342 causes the process to proceed to step S302.

(Step S302) Next, the image signal processing unit 342 initializes the color number N by for example making N=0. Then, the image signal processing unit 342 causes the process to proceed to step S303.

(Step S303) Next, the image signal processing unit 342 displays the color of the touch region being the color represented by the color number N, for a predetermined period of time on the display unit 21. Then, the image signal processing unit 342 causes the process to proceed to step S304.

(Step S304) Next, the image signal processing unit 342 determines whether or not a color change stop command has been received from the input device 10. If the color change stop command has been received (YES in step S304), the image signal processing unit 342 causes the process to proceed to step S305. On the other hand, if the color change stop command has not been received (NO in step S304), the image signal processing unit 342 causes the process to proceed to step S306.

(Step S305) In the case of “YES” in step S304, the image signal processing unit 342 determines the color of the touch region as the color represented by the color number N. Then, the image signal processing unit 342 ends the process shown in FIG. 8.

(Step S306) In the case of “NO” in step S304, the image signal processing unit 342 determines whether or not the color number N is greater than or equal to the maximum value M. If the color number N is greater than or equal to the maximum value M (YES in step S306), the image signal processing unit 342 causes the process to proceed to step S307. If the color number N is less than the maximum value M (NO in step S306), the image signal processing unit 34 causes the process to proceed to step S308.

(Step S307) In the case of “YES” in step S306, the image signal processing unit 342 changes the color number N to a predetermined color. That is to say, in the case where the color change stop command is still not received even when the cycle of the color change process has been completed, the color of the touch region is displayed with a predetermined color such as black color. As a result, for example, if the user makes a touch input by means of a finger, the display device 20 can perform drawing with the predetermined color. Then, the image signal processing unit 342 causes the process to proceed to step S305.

(Step S308) In the case of “NO” in step S306, the image signal processing unit 342 changes the color number N to the color number of the next candidate color. Then, the image signal processing unit 342 causes the process to return to step S303. [Second Operation of Input Device: Color Determination Process]

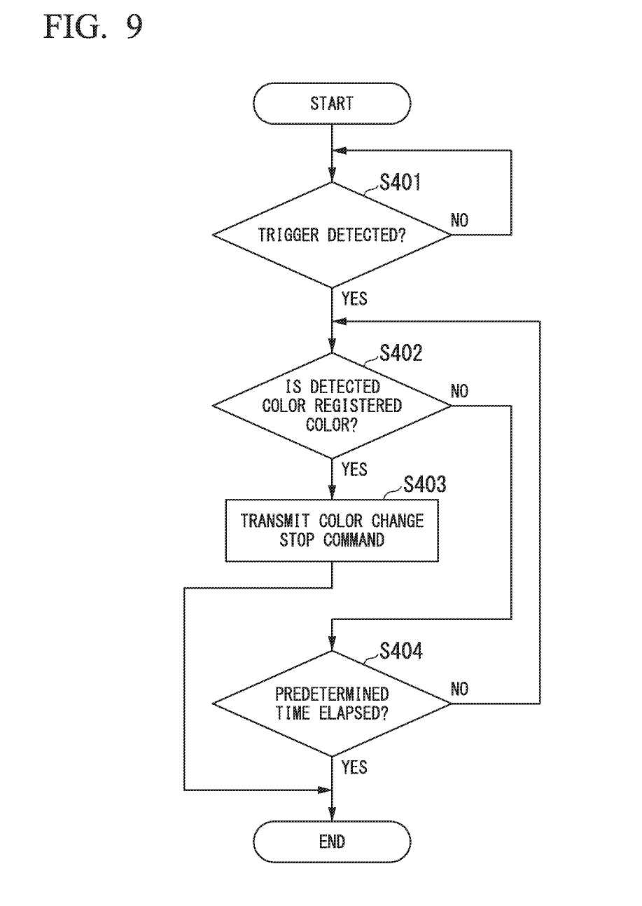

FIG. 9 is a flowchart showing an example of a flow of the color determination process performed in the input device 10 according to the first exemplary embodiment.

(Step S401) First, the color determination processing unit 162 of the input device 10 determines whether or not the color detected by the detection unit 11 is a trigger. If it is determined as being a trigger (YES in step S401), the color determination processing unit 162 causes the process to proceed to step S402. On the other hand, if it is determined as not being a trigger (NO in step S401), the color determination processing unit 162 causes the process to return to step S401.

(Step S402) In the case of “YES” in step S401, the color determination processing unit 162 compares the color number of the color detected by the detection unit 11 with the color number of a registered color stored in the memory unit 15, and determines whether or not the detected color is a registered color. If the detected color is a registered color (YES in step S402), the color determination processing unit 162 causes the process to proceed to step S403. On the other hand, if the detected color is not a registered color (NO in step S402), the process proceeds to step S404.

(Step S403) In the case of “YES” in step S402, the color determination processing unit 162 transmits a color change stop command to the information processing device 30 via the transmission unit 14. Then, the color determination processing unit 162 ends the process shown in FIG. 9.

(Step S404) In the case of “NO” in step S402, the color determination processing unit 162 determines whether or not a predetermined period of time has elapsed since the trigger color has been detected in the process of step S401. If the predetermined period of time has elapsed (YES in step S404), the color determination processing unit 162 ends the process shown in FIG. 9. If the predetermined period of time has not elapsed (NO in step S404), the color determination processing unit 162 causes the process to return to step S402.

As described above, the display system 1 according to the first exemplary embodiment includes an input device 10, a display device 20, and an information processing device 30. The information processing device 30 includes an image signal processing unit 342 that performs the color change process, in which the color of a part region of the image displayed on the display unit 21 of the display device 20 is sequentially changed, based on a color determination signal received from the input device 10. The input device 10 includes a color determination processing unit 162 that compares the color of an image displayed on the display device 20 with the color registered on the input device 10 itself, and transmits a color determination signal based on the comparison result to the display device 20 via the transmission unit 14.

As a result, the display system 1 can perform drawing with a color that the user desires, and can improve the level of color input operability.

Furthermore, the information processing device 30 performs the color change process after a trigger is displayed. Then the input device 10 performs the color determination process after the trigger has been detected.

As a result, the information processing device 30 can notify the input device 10 of the start of the color change process.

The image signal processing unit 342 of the information processing device 30 may store the image signal of the image at the time of completing the process shown in FIG. 8, into a nonvolatile memory provided in the information processing device 30, or may output it to another device such as the information processing device 30.

Moreover, the input device 10 includes a registration processing unit 161 that stores color information detected by the detection unit 11 into the memory unit 15, to thereby register it.

As a result, an arbitrary color that can be displayed on the display device 20 can be registered in the input device 10 for example. Consequently, the user can perform drawing with an arbitrary color that the user desires.

Therefore, the display system 1 can improve the level of color input operability.

Furthermore, the input device 10 includes an indicator unit 13 that notifies the input device 10 of start, completion, and failure of color registration.

As a result, the user can grasp the progress of the color registration process. Therefore, the display system 1 can improve the level of color input operability.

Moreover, the input device 10 transmits a color change stop command for stopping the color change process performed by the information processing device 30, as a color determination signal.

As a result, the display system 1 can determine the display color of the touch region by only transmitting a color change stop command once from the input device 10. That is to say, it is possible to reduce the amount of communication related processing, and reduce electric power consumption of the input device 10. Therefore, the display system 1 can improve the level of operability thereof.

### Second Exemplary Embodiment

### Brief Overview of Display System

Hereunder, a second exemplary embodiment of the present invention is described, with reference to the figures.

The same configurations as those in the first exemplary embodiment described above are denoted by the same reference symbols, and descriptions thereof are omitted.

First, a brief overview of a display system 1a according to the second exemplary embodiment is described, with reference to FIG. 10 and FIG. 11.

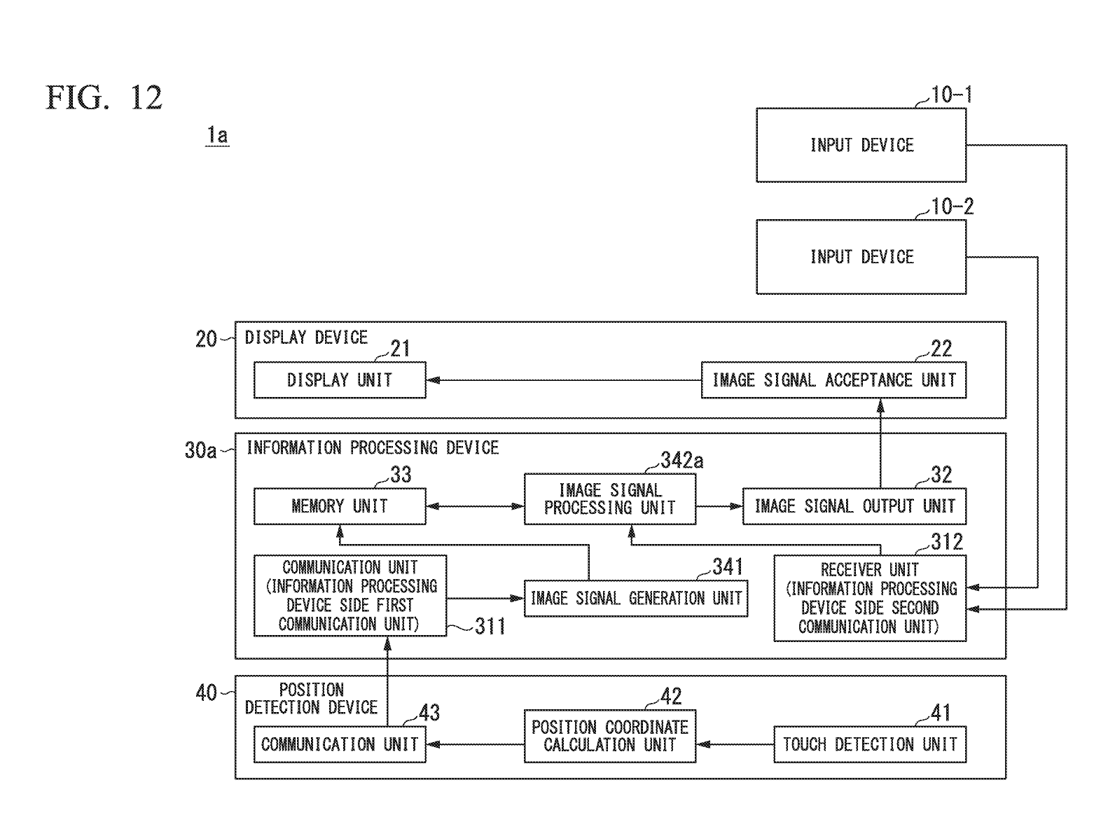

The display system 1a includes two input devices 10 (see FIG. 12) instead of the single input device 10 of the display system 1 (see FIG. 4). Furthermore, the display system 1a includes an information processing device 30a (see FIG. 12) instead of the information processing device 30 (see FIG. 4) of the display system 1. The display system 1a includes a plurality of input devices 10. The display system 1a performs drawing with a color specified by each of the plurality of input devices 10.

While two or more input devices 10 may be provided, here is described an example of the display system 1a including two input devices 10 as an example in order to simplify the description below.

FIG. 10 is a diagram for describing a brief overview of the display system 1a according to the second exemplary embodiment.

In the example shown in FIG. 10, as with the example shown in FIG. 2, the touch panel 50 is displaying color markers M1 through M3. In the example shown in FIG. 10, two input devices 10-1 and 10-2 are touching the touch panel 50 respectively in the touch regions 212 and 213. The information processing device 30a sequentially executes the color change process for changing display color with respect to each of these two touch regions 212 and 213. The order of the color change process may be determined based on the coordinate of the touch region. As an example, the following description is provided on the assumption that among the pixels of each of several touch regions by several input devices 10, the information processing device 30a compares the coordinate values of the pixels with minimum vertical direction coordinate values among the pixels with minimum horizontal direction coordinate values, with respect to the horizontal direction and the vertical direction, and the color change process is executed in ascending order of the coordinate values. Specifically, in the example shown in FIG. 10, in the case where the horizontal direction coordinate value becomes greater with approach from left to right and the vertical direction coordinate value becomes greater with approach from upper to lower, the horizontal direction coordinate value of the touch region 212 is less than the horizontal direction coordinate value of the touch region 213. Therefore, after having performed the color change process for the touch region 212, the information processing device 30a executes the color change process for the touch region 213.

### [Brief Overview of Color Change Process]

FIG. 11 is a diagram for describing a brief overview of the color change process according to the second exemplary embodiment.

FIG. 11 shows temporal changes in the color of the regions 212 and 213 shown in FIG. 10. In the example shown in FIG. 11, the horizontal axis represents time t, showing the time shifting from the point in time T1′ through to the point in time T10′. That is to say, the information processing device 30a sequentially changes the color of the touch regions 212 and 213 to the colors associated respectively with the point in time T1′ through to the point in time T10′ in FIG. 11. Specifically, unless a color change stop command is received from each of the input devices 10-1 and 10-2, the information processing device 30a changes the color of the touch regions 212 and 213, for example, in the order of white color, black color, white color, red color, blue color, green color, and black color. As described with reference to FIG. 10, after having performed the color change process for the touch region 212, the information processing device 30a executes the color change process for the touch region 213. To give a specific example with reference to FIG. 11, for example, in the case where the registered color of the input device 10-1 is red color, the information processing device 30a first sequentially changes the display color of the touch region 212, and determines the display color of the touch region 212 based on the color change stop command that is received from the input device 10-1 at the point in time T4′. Next, the information processing device 30a starts to change the display color of the touch region 213 from the point in time T5′, and determines the display color of the touch region 213 based on the color change stop command received from the input device 10-2. In this manner, the information processing device 30a executes the color change process of several touch regions in a time-shifted manner. Thereby, the corresponding touch regions can be displayed with the respective registered colors of several input devices 10-1 and 10-2.

### [Configuration of Input Device]

Next, the configurations of various devices included in the display system 1a are described, with reference to FIG. 12.

FIG. 12 is a block diagram showing a schematic function configuration of the input devices 10-1 and 10-2, the information processing device 30a, and peripheral devices according to the present exemplary embodiment.

The configurations provided in the input devices 10-1 and 10-2 are the same as that of the input device 10, and therefore description will be omitted. Moreover, the configurations of the display device 20 and the position detection device 40 are also the same as those of the above exemplary embodiment, and therefore, description will be omitted.

### [Configuration of Display Device]

The information processing device 30a includes an image signal processing unit 342a (see FIG. 12) instead of the image signal processing unit 342 (see FIG. 4) of the information processing device 30 (see FIG. 4).

In addition to the function provided in the image signal processing unit 342, the image signal processing unit 342a performs a process of separating touch regions, for touches that are simultaneously performed on the touch panel 50. In this process, the image signal processing unit 342a first generates a frame image as described with reference to FIG. 5. Next, in the generated frame image, the image signal processing unit 342a separates regions where inputs are detected, based on the consecutiveness of the inputs. Specifically, the image signal processing unit 342a determines whether or not the input pixels are respectively consecutive in the horizontal direction, vertical direction, or diagonal direction. Consecutiveness here means, for example, that input pixels are distanced from each other by a few pixels in each direction. In this manner, the image signal processing unit 342a identifies each of the separated regions of the frame image as touch regions that correspond to touches performed by different input devices 10 or fingers.

The image signal processing unit 342a decides the order in which the color change process is performed on each identified touch region. The order in which the color change process is performed is decided as described above, based on the coordinate value of each touch region for example. The image signal processing unit 342a sequentially performs the color change process of each touch region, in the decided order.

### [Operation of Display Device]

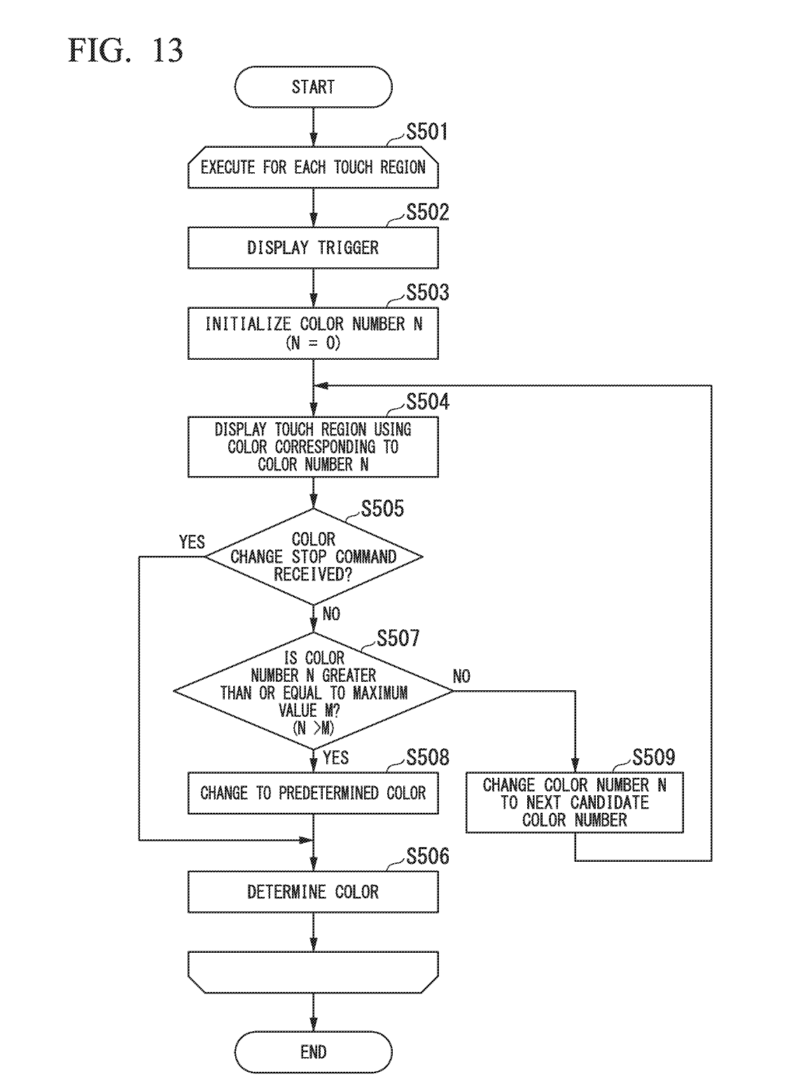

Next, operations of the information processing device 30a are described, with reference to FIG. 13.

FIG. 13 is a flowchart showing an example of a flow of a color change process performed in the information processing device 30a according to the second exemplary embodiment.

(Step S501) The image signal processing unit 342a (see FIG. 12) executes the processes of step S502 through step S509, for each touch region identified from the frame image. The image signal processing unit 342a repeatedly executes the processes of step S502 through step S509, until there is no unprocessed touch region. Then, the image signal processing unit 342a ends the process shown in FIG. 13. The processes of step S502 through step S509 respectively correspond to the processes of step S301 through step S308 described with reference to FIG. 8, and therefore the descriptions thereof are omitted.

As described above, in the display system 1a according to the second exemplary embodiment, the image signal processing unit 342a of the information processing device 30a performs the color change process for each of several touch regions, if several touch regions have been identified.

As a result, even in the case where inputs are made on the touch panel 50 using several input devices 10, the display system 1a can perform drawing with the color registered in each input device 10. Therefore, the display system 1a can improve the level of color input operability.

### [Modified Example of Display System]

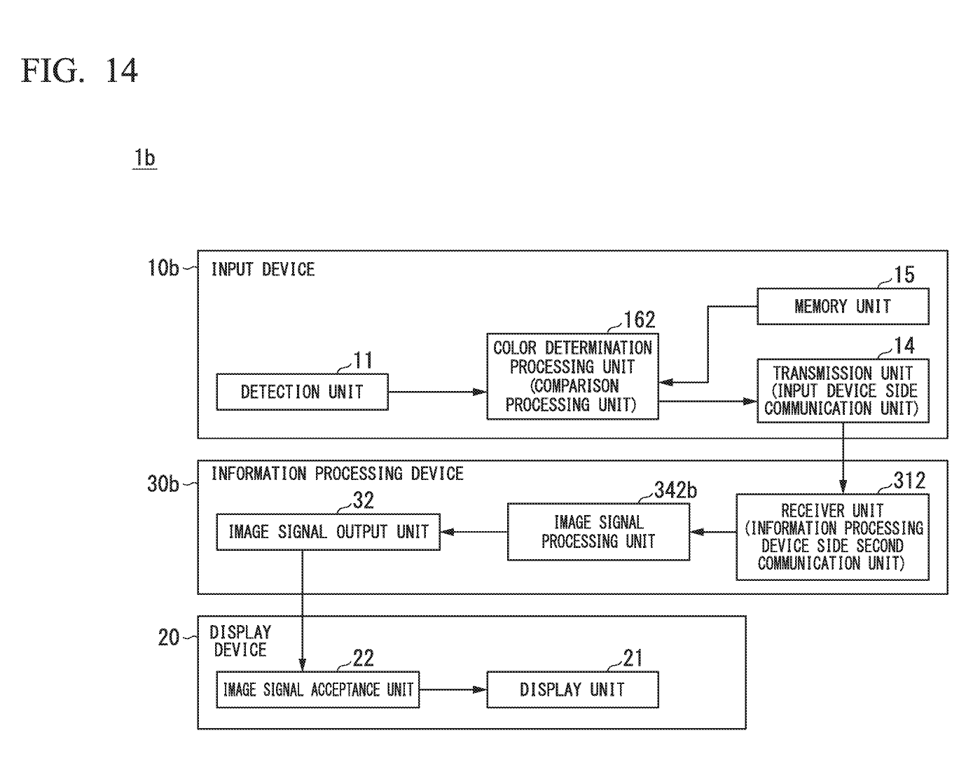

Next, a modified example of the display system according to each exemplary embodiment mentioned above is described, with reference to FIG. 14.

FIG. 14 is a block diagram showing a schematic function configuration of a display system 1b according to the modified example.

The display system 1b of the modified example includes an input device 10b, an information processing device 30b, and a display device 20.

The information processing device 30b includes a receiver unit (information processing device side second communication unit) 312 that communicates with the input device 10b, an image signal processing unit 342b, and an image signal output unit 32 that outputs an image signal processed in the image signal processing unit 342b to the display device 20.

Based on a color determination signal that the receiver unit 312 receives from the input device 10b, the image signal processing unit 342b performs the color change process, in which the color of an image to be displayed on the display device 20 is sequentially changed.

The display device 20 includes an image signal acceptance unit 22 and a display unit 21.

The image signal acceptance unit 22 accepts an image signal output from the image signal output unit 33 of the information processing device 30b.

The display unit 21 displays an image represented by the image signal accepted by the image signal acceptance unit 22.

The input device 10b includes a detection unit 11, a transmission unit (input device side communication unit) 14, a memory unit 15, and a color determination processing unit 162.

The detection unit 11 detects color information related to the color of the image displayed on the display unit 21.

The memory unit 15 stores color information.

The color determination processing unit 162 compares the color information detected by the detection unit 11 with the color information stored in the memory unit 15.

The transmission unit 14 transmits a color determination signal to the display device 20, based on the comparison result of the color determination processing unit 162.

As a result, the display system 1b can perform drawing with a color that the user desires, and can improve the level of color input operability.

In each exemplary embodiment described above, the information processing devices 30 and 30a may be an electronic device that includes a touch panel, such as a personal computer, a mobile phone, a tablet, a smartphone, a PHS (personal handy-phone system) terminal device, a PDA (personal digital assistant), and a game console.

In each exemplary embodiment described above, the image signal processing units 342, 342a, and 342b of the information processing devices 30, 30a, and 30b may perform color number change in the color change process in a one-by-one manner.

Specifically, in step S308 of FIG. 8, the image signal processing unit 342 may change the color by adding 1 to the color number N (N=N+1). At this time, for example, in the case where the detected color matches completely with the color of the color number registered in the input device 10 itself, the input device 10 transmits a color change stop command to the information processing device 30. As a result, the information processing device 30 can reliably match the display color of the touch region with the registered color of the input device 10, and the color desired by the user can be reproduced more accurately.

Moreover, the order of the colors displayed in the color change process may be arbitrarily defined by the user. For example, in the color change process, the information processing devices 30, 30a, and 30b may change color in descending order of the color number.

In each exemplary embodiment described above, the arbitrary configurations of the information processing devices 30, 30a, and 30b may be provided in another device such as the display device 20. The display device 20, the information processing devices 30, 30a, and 30b, and the position detection device 40 may be of a combined device. However, by having the information processing devices 30, 30a, and 30b executing the color change process in the manner seen in each exemplary embodiment described above, the display device 20 does not have to be provided with a special configuration for performing the color change process.

Furthermore, in each exemplary embodiment described above, the input devices 10 and 10b may be able to register several colors. In this case, the input devices 10 and 10b are provided, for example, with a button for the user to select any one of the registered colors, and perform the color determination process based on the registered color selected by the button being pressed down. As a result, there is no need for the user to make the input devices 10 and 10b perform the color registration process every time when the registered color is changed, and therefore, the display system 1 can improve the level of color input operability.

Moreover, the color number of the registered color may be preliminarily stored in the memory unit 15 of the input devices 10 and 10b. In this case, the input devices 10 and 10b perform the color determination process based on the color number of the preliminarily stored registered color.

Part of the input devices 10 and 10b, the display device 20, the information processing devices 30, 30a, and 30b, and the position detection device 40 in each exemplary embodiment described above, such as the registration processing unit 161, the color determination processing unit 162, the image signal processing units 342, 342a, and 342b, the image signal generation unit 341, and the position coordinate calculation unit 42 may be realized by means of a computer. In this case, a program for realizing these functions may be recorded on a computer-readable recording medium, and the program recorded on this recording medium may be loaded and executed on a computer system, to thereby realize the functions. The “computer system” here refers to a computer system built into the input device 10, the display device 20, the information processing devices 30, 30a, and 30b, and/or the position detection device 40, and includes an OS (operating system) and hardware such as peripheral devices.

Moreover, the “computer-readable recording medium” refers to a portable medium such as a flexible disk, a magnetic optical disk, a ROM, and a CD-ROM, and/or a memory device such as a hard disk drive built into a computer system. Furthermore, the “computer-readable recording medium” may include one that dynamically retains a program for a short period of time such as a communication line in the case of transmitting the program via a network including the Internet, or a communication line including a telephone line, and may also include one that retains a program for a certain period of time such as a volatile memory inside a computer system serving as a server or client in this type of case. The program above may realize part of the functions described above, and may also realize the above mentioned functions in combination with a program that is preliminarily recorded on a computer system.

Furthermore, part or all of the input devices 10 and 10b, the information processing devices 30, 30a, and 30b of the display device 20, and the position detection device 40 in the exemplary embodiments described above may be realized as an integrated circuit such as an LSI (large scale integrated circuit). Each functional unit of the input devices 10 and 10b, the display device 20, the information processing devices 30, 30a, and 30b, and the position detection device 40 may be provided in the form of a separate processor, and part or all of the functional units may be integrated as a processor. Moreover, the method of circuit integration is not limited to LSI, and it may be realized by means of a dedicated circuit or a general-purpose processor. Furthermore, if a circuit integration technique replaces LSI as a result of advancement of semiconductor technology, an integrated circuit of this technique may be used.

Exemplary embodiments of the present invention have been described in detail, with reference to the figures. However, the specific configurations are not limited to those described above, and various design modifications may be made without departing from the scope of the invention.

### (Supplementary Note 1)

A display system includes: an information processing device; a display device; and a first input device, the information processing device including: a receiver unit that receives a first color determination signal from the first input device; an image signal processing unit that processes an image signal representing an image, the image including the first region, the image signal processing unit sequentially changing a first target color that is a color to be displayed in the first region, the image signal processing unit stopping the change of the first target color in response to the receiver unit receiving the first color determination signal; and an image signal output unit that outputs the image signal to the display device, the display device including: an image signal acceptance unit that accepts the image signal; and a display unit that displays the image represented by the image signal, the first input device including: a first detection unit that detects the first target color displayed on the display unit, the first detection unit acquiring first target color information that is color information representing the first target color; a first memory unit that stores first registered color information; a first color determination processing unit that determines whether the first target color information is matched with the first registered color information, the first color determination processing unit generating the first color determination signal when the first color determination processing unit has determined that the first target color information is matched with the registered color information; and a first transmission unit that transmits the first color determination signal to the information processing device.

What is claimed is:

1. A display system comprising:
an information processing device;
a display device; and
a first input device,
the information processing device including:
a receiver unit that receives a first color determination signal from the first input device;
an image signal processing unit that processes an image signal representing an image, the image including the first region, the image signal processing unit sequentially changing a first target color that is a color to be displayed in the first region, the image signal processing unit stopping the change of the first target color in response to the receiver unit receiving the first color determination signal; and
an image signal output unit that outputs the image signal to the display device,
the display device including:
an image signal acceptance unit that accepts the image signal; and
a display unit that displays the image represented by the image signal,
the first input device including:
a first detection unit that detects the first target color displayed on the display unit, the first detection unit acquiring first target color information that is color information representing the first target color;
a first memory unit that stores first registered color information;
a first color determination processing unit that determines whether the first target color information is matched with the first registered color information, the first color determination processing unit generating the first color determination signal when the first color determination processing unit has determined that the first target color information is matched with the registered color information; and
a first transmission unit that transmits the first color determination signal to the information processing device.

2. The display system according to claim 1, further comprising:
a position detection device that detects position information that represents an input position at which an input to the display unit has been performed by the first input device,
wherein the first region includes a region corresponding to the input position represented by the position information.

3. The display system according to claim 2, wherein
the information processing device further includes an image signal generation unit that generates the image signal based on the position information, and
the image signal processing unit causes the display unit to display the image.

4. The display system according to claim 1, wherein
the image signal processing unit changes the first target color to a predetermined color before the image signal processing unit sequentially changes the first target color,
the first memory unit stores trigger information representing the predetermined color,
the first color determination processing unit determines whether the first target color information is matched with the trigger information, and
the first color determination processing unit determines whether the first target color information is matched with the first registered color information when the first color determination processing unit has determined that the first target color information are matched with the trigger information.

5. The display system according to claim 1, wherein
the first storage unit stores therein a second image signal representing a second image corresponding to a second frame after the first storage unit stores therein a first image signal representing a first image corresponding to a first frame, and
the first region includes a region formed by a pixel where a display is different between the first and second images.

6. The display system according to claim 1, further comprising:
a second input device that is different from the first input device, wherein
the receiver unit receives a second color determination signal from the second input device;
the image further includes a second region different from the first region,
the image signal processing unit sequentially changes a second target color that is a color to be displayed in the second region,
the image signal processing unit stops the change of the second target color in response to the receiver unit receiving the second color determination signal, and
the second input device includes:
a second detection unit that detects the second target color displayed on the display unit, the second detection unit acquiring second target color information that is color information representing the second target color;
a second memory unit that stores second registered color information;
a second color determination processing unit that determines whether the second target color information is matched with the second registered color information, the second color determination processing unit generating the second color determination signal when the second color determination processing unit has determined that the second target color information is matched with the registered color information; and
a second transmission unit that transmits the second color determination signal to the information processing device.

7. The display system according to claim 6, wherein the image signal processing unit sequentially changes the second target color after the image signal processing unit sequentially changes the first target color.

8. The display system according to claim 1, wherein
the first detection unit detects a displayed color displayed on the display unit, and acquires displayed color information that is color information representing the displayed color;
the first input device further includes a first registration processing unit that stores, in the first memory unit, the displayed color information as the first registered color information.

9. The display system according to claim 8, wherein the first input device further includes a first notification unit that notifies that the first registration processing unit has stored the first registered color information into the first memory unit.

10. The display system according to claim 1, wherein the image signal processing unit stores color change image information into a nonvolatile memory or outputs the color change image information to another device, the color change image information representing the image that is being displayed on the display unit when the image signal processing unit stops the change of the first target color.

11. An information processing device comprising:
an image signal processing unit that processes an image signal representing an image, the image including the region, the image signal processing unit sequentially changing a color to be displayed in the region;
an image signal output unit that outputs the image signal to a display device; and
a receiver unit that receives, from an input device, a signal that instructs to stop the change of the color,
the image signal processing unit stopping the change of the color in response to the receiver unit receiving the signal.

12. A display method for a display system, the display system including an information processing device, a display device, and a first input device, the first input device storing first registered color information, the display method comprising:
outputting an image signal to the display device by means of the information processing device, the image signal representing an image including the first region;
accepting the image signal by means of the display device;
displaying the image represented by the image signal by means of the display device;
sequentially changing a first target color that is a color to be displayed in the first region, by means of the information processing device;
detecting the first target color by means of the first input device;
acquiring first target color information that is color information representing the first target color, by means of the first input device;
determining whether the first target color information is matched with the first registered color information, by means of the first input device;
generating a first color determination signal by means of the first input device when it has been determined that the first target color information is matched with the first registered color information;
transmitting the first color determination signal by means of the first input device; and
stopping the change of the first target color by means of the information processing device, in response to the first color determination signal being received.

13. The display method according to claim 12, further comprising:
outputting, to the display device, an image signal representing an image in which the first target color is a color at the time of stopping the change of the first target color, by means of the information processing device.
